(19) United States
(12) Patent Application Publication
(10) Pub. No.: US 2013/0169349 A1
(43) Pub. Date: Jul. 4, 2013

(54) ANTI-FUSE CIRCUIT

(71) Applicant: Hoe Kwon JUNG, Icheon-si (KR)

(72) Inventor: Hoe Kwon JUNG, Icheon-si (KR)

(73) Assignee: SK HYNIX INC., Icheon-si (KR)

(21) Appl. No.: 13/588,187

(22) Filed: Aug. 17, 2012

(30) Foreign Application Priority Data
Dec. 29, 2011 (KR) 10-2011-0146440

(51) Int. Cl. H01H 85/05

(52) U.S. Cl. 327/525

(57) ABSTRACT

An anti-fuse circuit includes: a first fuse unit including a first anti-fuse which is determined to be short-circuited if the first anti-fuse in a programmed state and determined not to be short-circuited if the first anti-fuse in a non-programmed state, and configured to generate an output signal according to a state of the anti-fuse and a restoration signal; and a second fuse unit including a second anti-fuse, and configured to activate the restoration signal when the second anti-fuse is in the programmed state in case where the first anti-fuse is in the programmed state.

### CROSS-REFERENCES TO RELATED APPLICATION

The present application claims priority under 35 U.S.C. §119(a) to Korean application number 10-2011-0146440 filed on Dec. 29, 2011, in the Korean Intellectual Property Office, which is incorporated herein by reference in its entirety.

### BACKGROUND

1. Technical Field

The present invention relates generally to a semiconductor integrated circuit, and more particularly to an anti-fuse circuit.

2. Related Art

A defective cell of a semiconductor apparatus may cause a is failure of the semiconductor apparatus. However, it is inefficient to discard the semiconductor apparatus having only a small number of defective cells. Therefore, the semiconductor apparatus may be repaired by replacing the failed cells with redundancy cells prepared therein, which makes it possible to improve the yield.

A repair operation using redundancy cells may be performed not only at a wafer level but also at a package level. At the wafer level, a fuse is used to perform the repair operation. For example, the repair operation using a fuse may include a method of cutting a fuse existing in a line connected to a row or column having a failed cell by applying an over current, a method of burning a fuse using laser beams, a method of connecting junctions using laser beams, and a method of programming a fuse through EPROM, in order to replace failed cells with redundancy cells

On the other hand, the repair operation using a fuse may not be performed at the package level. Therefore, an anti-fuse is adopted to perform a repair operation. The anti-fuse has a resistive fuse element having an electrical characteristic opposite to the fuse. In general, the anti-fuse may comprise a thin dielectric material such as a dielectric such as SiO₂, silicon nitride, tantalum oxide, or ONO (silicon dioxide-silicon nitride-silicon dioxide) interposed between two conductors. The two conductors of the anti-fuse are electrically isolated from each other in a normal state, e.g., non-programmed state. However, when a high voltage is applied to destroy the dielectric between the conductors, the two conductors of the anti-fuse is are electrically connected to each other. That is, when a repair operation using an anti-fuse is performed at the package level, a programming operation is performed to apply a high voltage to an anti-fuse circuit. After the programming operation, the anti-fuse is short-circuited to thereby replace the failed cell with a redundancy cell.

FIG. 1 is a known anti-fuse circuit provided in a semiconductor apparatus.

The known anti-fuse circuit includes a high voltage generation unit 1 for generating a high voltage VHIGH, a control unit 2, and a fuse unit 3.

The high voltage generation unit 1 is configured to generate a high voltage VHIGH used for programming an anti-fuse. The high voltage VHIGH may be generated from an external voltage by using a charge pump.

The control unit 2 is configured to control a repair operation for a corresponding memory cell (e.g., in the unit of row or column) through a rupture signal RUP_SELB. That is, when a failed memory cell is detected at the package level, the rupture signal RUP_SELB can indicate whether a corresponding anti-fuse is in a programmed state. If the corresponding anti-fuse is in the programmed state, the rupture signal RUP_SELB is activated.

The fuse unit 3 includes an anti-fuse. The anti-fuse is programmed by applying the high voltage VHIGH in response to the rupture signal RUP_SELB. As the high voltage VHIGH is applied to the anti-fuse, the dielectric thereof is destroyed, and thus the anti-fuse is short-circuited to thereby activate an output signal RUP_ON. When the output signal RUP_ON is activated, a failed memory cell is replaced with a corresponding redundancy memory cell.

FIG. 2 is a waveform diagram illustrating the operation of the anti-fuse circuit.

At the initial stage, the anti-fuse circuit is reset by a power-up signal PWU. Then, the rupture signal RUP_SELB is activated to indicate programmed state of the corresponding anti-fuse. The rupture signal RUP_SELB, which is a pulse signal, is activated to a low level.

The anti-fuse circuit programs the anti-fuse into a short-circuited state by applying the high voltage VHIGH in response to the rupture signal RUP_SELB. As a result, the output signal RUP_ON is activated.

The known anti-fuse circuit cannot be restored to the original state, once the high voltage is applied to destroy the anti-fuse. However, because of various reasons including a case where an anti-fuse is destroyed due to a programming error or the like, the anti-fuse needs to be restored into the original state.

### SUMMARY

In an embodiment of the present invention, an anti-fuse circuit includes: a first fuse unit including a first anti-fuse which is decided to be shorted or not in response to whether programming is was performed or not, and configured to generate an output signal in response to a state of the anti-fuse and a restoration signal; and a second fuse unit including a second anti-fuse, and configured to activate the restoration signal when the second anti-fuse is shorted in case where the first anti-fuse is shorted.

In an embodiment of the present invention, an anti-fuse circuit includes: a control unit configured to generate first and second rupture signals; a first fuse unit including a first anti-fuse, and configured to decide whether or not to short the first anti-fuse in response to the first rupture signal, and generate an output signal in response to a state of the first anti-fuse and a restoration signal; and a second fuse unit including a second anti-fuse, and configured to decide whether or not to short the second anti-fuse in response to the second rupture signal, and activate the restoration signal according to a state of the second anti-fuse.

In an embodiment of the present invention, an anti-fuse circuit includes: a high voltage generation unit configured to generate a high voltage; a control unit configured to activate a first rupture signal during fuse programming, and then activate a second rupture signal when the fuse programming is to be restored; a fuse unit including a first anti-fuse, and configured to decide whether or not to short the first anti-fuse in response to the first rupture signal, and generate an output signal in response to a state of the first anti-fuse and a restoration signal; and a restoration control unit including a second anti-fuse, and configured to decide whether or not to short is the second anti-fuse in response to the second rupture signal, and activate the restoration signal according to a state of the second anti-fuse.

### BRIEF DESCRIPTION OF THE DRAWINGS

Features, aspects, and embodiments are described in conjunction with the attached drawings, in which:

FIG. 1 is a known anti-fuse circuit provided in a semiconductor apparatus;

FIG. 2 is a waveform diagram illustrating the operation of the known anti-fuse circuit;

FIG. 3 is a block diagram illustrating an anti-fuse circuit according to an embodiment of the present invention;

FIG. 4 is a circuit diagram illustrating a first fuse unit of FIG. 3;

FIG. 5 is a circuit diagram illustrating a second fuse unit of FIG. 3; and

FIGS. 6A and 6B are waveform diagrams illustrating the operation of the anti-fuse circuit according to an embodiment of the present invention.

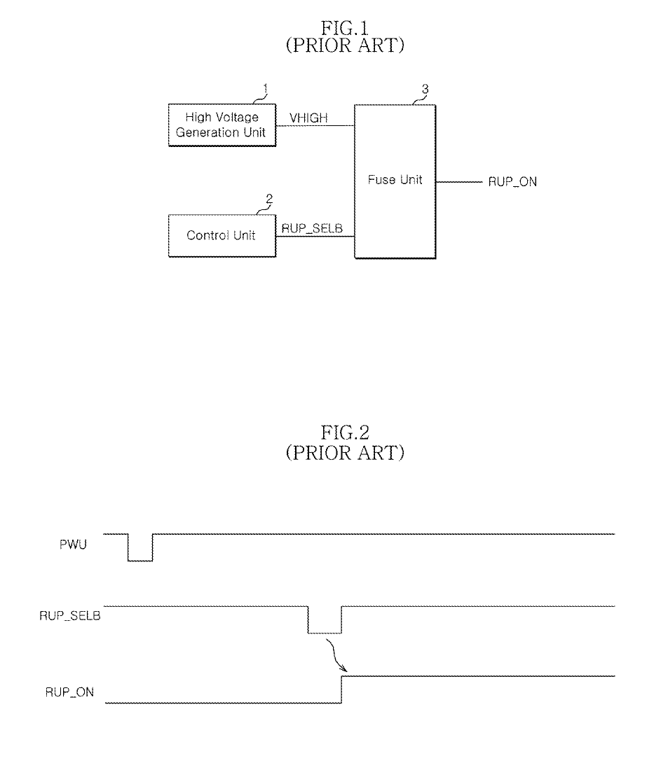

### DETAILED DESCRIPTION

Hereinafter, an anti-fuse circuit according to the present invention will be described below with reference to the accompanying drawings through exemplary embodiments.

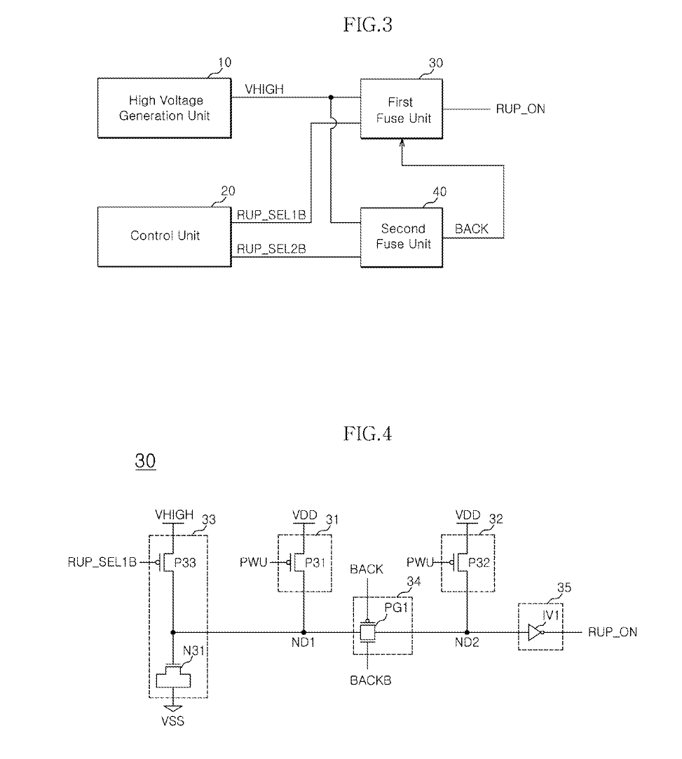

FIG. 3 is a block diagram illustrating an anti-fuse circuit according to an embodiment of the present invention.

The anti-fuse circuit includes a high voltage generation unit 10, a control unit 20, a first fuse unit 30, and a second fuse unit 40.

The high voltage generation unit 10 is configured to generate a high voltage used for programming an anti-fuse. The high voltage may be generated from an external voltage by using a charge pump. The anti-fuse circuit according to an embodiment of the present invention may include the high voltage generation unit 10, or may receive a high voltage VHIGH from outside.

The control unit 20 is configured to generate a first rupture signal RUP_SEL1B to control a programming operation for an anti-fuse of the first fuse unit 30, and generate a second rupture signal RUP_SEL2B to control a programming operation for an anti-fuse of the second fuse unit 40.

According to an embodiment of the present invention, the first rupture signal RUP_SEL1B is activated for programming of the anti-fuse circuit of the first fuse unit 30, and the second rupture signal RUP_SEL2B is activated for the programming operation of the anti-fuse circuit of the second fuse unit 40. If the anti-fuse circuit of the second fuse unit 40 is programmed, the first fuse unit 30 may operate as if the anti-fuse circuit of the first fuse unit 30 is restored, e.g., as if the anti-fuse circuit of the first fuse unit 30 is not programmed. The control unit 20 may activate the second rupture signal RUP_SEL2B according to a command applied from outside or a is command of internal control logic.

The first fuse unit 30 includes an anti-fuse configured to receive the high voltage VHIGH in response to the first rupture signal RUP_SEL1B. The anti-fuse does not conduct electricity in a normal state, e.g., a non-programmed state. However, when the high voltage VHIGH is applied to destroy a dielectric of the anti-fuse, the anti-fuse becomes short-circuited. According to the state of the anti-fuse and a restoration signal BACK, the first fuse unit 30 generates an output signal RUP_ON of the anti-fuse circuit.

The second fuse unit 40 includes an anti-fuse configured to receive the high voltage VHIGH in response to the second rupture signal RUP_SEL2B. The anti-fuse does not conduct electricity in a normal state, e.g., a non-programmed state. However, when the high voltage VHIGH is applied to destroy a dielectric of the anti-fuse, the anti-fuse becomes short-circuited. According to the state of the anti-fuse, e.g., when the anti-fuse becomes short-circuited, i.e., when the two conductors of the anti-fuse are electrically connected to each other, the second fuse unit 40 activates the restoration signal BACK. As such, the second fuse unit 40 controls the restoration of the anti-fuse circuit.

The operation of the anti-fuse circuit will be briefly described as follows. The first fuse unit 30 programs the anti-fuse according to a programming command, and outputs the output signal RUP_ON. The second fuse unit 40 activates the restoration signal BACK by programming the anti-fuse included therein, when the programmed is anti-fuse of the first fuse unit 30 needs to be restored. When the restoration signal BACK is activated, the first fuse unit 30 deactivates the output signal RUP_ON, even though the anti-fuse circuit of the first fuse unit 30 has been programmed.

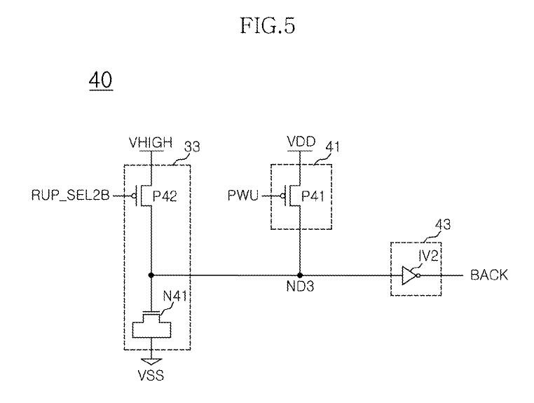

FIG. 4 is a circuit diagram illustrating the first fuse unit 30.

The first fuse unit 30 includes a first reset section 31, a second reset section 32, a first anti-fuse section 33, a disconnection section 34, and a first buffer section 35.

The first reset section 31 is configured to apply an external voltage VDD to a first node ND1 in response to a power-up signal PWU.

The second initialization section 32 is configured to apply the external voltage VDD to a second node ND2 in response to the power-up signal PWU.

The power-up signal PWU is a signal which is activated when power is stabilized after the power is applied to the semiconductor apparatus. For example, the power-up signal PWU may be set to a pulse signal activated to a low level.

The first and second reset sections 31 and 32 are configured to reset the anti-fuse circuit according to an embodiment of the present invention, during power up.

The first reset section 31 may include a first PMOS transistor P31. The first PMOS transistor P31 has a gate terminal receiving the power-up signal PWU, a source terminal coupled to the external voltage VDD node, and a drain terminal coupled to the first node ND1. Therefore, the first reset section 31 resets the first node ND1 to a high level during power up.

The second reset section 32 may include a second PMOS transistor P32. The second PMOS transistor P32 has a gate terminal receiving the power-up signal PWU, a source terminal coupled to the external voltage VDD node, and a drain terminal coupled to the second node ND2. Therefore, the second reset section 32 resets the second node ND2 to a high level during power up.

The first anti-fuse section 33 is configured to apply the high voltage VHIGH to the anti-fuse therein in response to the first rupture-signal RUP_SEL1B. According to the state of the anti-fuse, the level of the first node ND1 changes.

The first anti-fuse section 33 may include a third PMOS transistor P33 and a first anti-fuse N31.

The third PMOS transistor P33 has a gate terminal receiving the first rupture signal RUP_SEL1B, a source terminal coupled to the high voltage VHIGH node, and a drain terminal coupled to the first node ND1. The third PMOS transistor P33 is configured to apply the high voltage VHIGH to the first anti-fuse N31 in response to the first rupture signal RUP_SEL1B.

The first anti-fuse N31 is coupled between the first node ND1 and a ground voltage VSS. In an embodiment of the present invention, the first anti-fuse N31 may include a gate oxide anti-fuse which loses the property of an NMOS transistor and create an electrically conductive path when receiving the high voltage VHIGH through the gate terminal thereof. In addition, various types of anti-fuses may be used.

In a normal state after power up process, e.g., in a non-programmed state, the two conductors of the anti-fuse are electrically isolated from each other, and the third PMOS transistor P33 is turned off. Therefore, the first node ND1 maintains a high level as an initial value.

In a programming process, however, since the third PMOS transistor P33 is turned on according to the activated first rupture signal RUP_SEL1B, the high voltage VHIGH is applied to the first anti-fuse N31. Then, as the dielectric of the first anti-fuse N31 is destroyed, the first anti-fuse N31 is short-circuited, i.e., the two conductors of the anti-fuse are electrically connected to each other. Therefore, the first node ND1 is electrically connected to the ground voltage VSS node.

The disconnection section 34 is configured to connect the first and second nodes ND1 and ND2 in response to the restoration signal BACK.

The disconnection section 34 may include a first pass gate PG1 configured to receive the restoration signal BACK and an inverted signal BACKB of the restoration signal BACK through gate terminals thereof, respectively, and electrically connect the first and second nodes ND1 and ND2 to each other.

At the initial stage, the restoration signal BACK is applied in a deactivation state at a low level. Accordingly, the first pass gate PG1 electrically connects the first and second nodes ND1 and ND2, and, for example, the first and second nodes ND1 and ND2 are reset to a high level. If the first anti-fuse N31 is programmed, the first and second nodes ND1 and ND2 change to a low level.

On the other hand, when the restoration signal BACK is applied in an activation state at a high level, the first pass gate PG1 electrically disconnects the first and second nodes ND1 and ND2. Therefore, after next power up process, the output signal RUP_ON is generated according to the voltage level of the second node ND2, regardless of the voltage level of the first node ND1.

The first buffer section 35 is configured to invert and buffer the voltage level of the second node ND2 and output the inverted voltage level of the second node ND2 as the output signal RUP_ON. The first buffer section 35 may include a first inverter IV1 to invert the voltage level of the second node ND2.

Since the second node ND2 is at a high level during an initial normal operation, the first buffer section 35 generates the output signal RUP_ON deactivated at a low level. On the other hand, since the voltage level of the second node ND2 changes to a low level after the programming operation for the first anti-fuse N31, the first buffer section 35 generates the output signal RUP_ON activated to a high level.

Then, however, when the restoration signal BACK is activated, the first and second nodes ND1 and ND2 are electrically disconnected to each other. Therefore, during next power up process, the first buffer section 35 generates the output signal RUP_ON deactivated to a low level according to the reset level of the second node ND2, regardless of whether the first anti-fuse N31 has been programmed or not.

FIG. 5 is a circuit diagram illustrating the second fuse unit 40.

The second fuse unit 40 includes a third reset section 41, a second anti-fuse section 42, and a second buffer section 43.

The third reset section 41 is configured to apply the external voltage VDD to a third node ND3 in response to the power-up signal PWU.

The third reset section 41 may include a fourth PMOS transistor P41. The fourth PMOS transistor P41 has a gate terminal receiving the power-up signal PWU, a source terminal coupled to the external voltage VDD node, and a drain terminal coupled to the third node ND3. Therefore, the third reset section 41 resets the third node ND3 to a high level during power up.

The second anti-fuse section 42 applies the high voltage VHIGH to an anti-fuse therein in response to the second rupture signal RUP_SEL2B. According to the state of the anti-fuse, the voltage level of the third node ND3 changes.

The second anti-fuse section 42 may include a fifth PMOS transistor P42 and a second anti-fuse N41.

The fifth PMOS transistor P42 has a gate terminal receiving the second rupture signal RUP_SEL2B, a source terminal coupled to the high voltage VHIGH node, and a drain terminal coupled to the third node ND3. The fifth PMOS transistor P42 is configured to apply the high voltage VHIGH to the second anti-fuse N41 in response to the second rupture signal RUP_SEL2B.

The second anti-fuse N41 is coupled between the third node ND3 and the ground voltage VSS. In an embodiment of the present invention, the second anti-fuse N41 may include a gate oxide anti-fuse which loses the property of an NMOS transistor and create an electrically conductive path when receiving the high voltage VHIGH through a gate terminal thereof. In addition, various types of anti-fuses may be used.

Before the second rupture signal RUP_SEL2B corresponding to a programming restoration command is activated, the second anti-fuse N31 is in a non-programmed state, i.e., the two conductors of the anti-fuse are electrically isolated from each other, and the fifth PMOS transistor P42 is turned off. Therefore, the third node ND3 maintains a high level as an initial value.

However, when the second rupture signal RUP_SEL2B is activated, the fifth PMOS transistor P42 is turned on to apply the high voltage VHIGH to the second anti-fuse N41. Then, as the dielectric of the second anti-fuse N41 is destroyed, the second anti-fuse N41 is short-circuited, i.e., the two conductors of the anti-fuse are electrically connected to each other to thereby connect the third node ND3 to the ground voltage VSS node.

The second buffer section 43 is configured to invert and buffer the voltage level of the third node ND3 and output the inverted voltage level of the third node ND3 as the restoration signal BACK. The second buffer section 43 may include a second inverter IV2 configured to invert the voltage level of the third node ND3.

Since the third node ND3 is initially at a high level, the second buffer section 43 generates the restoration signal BACK deactivated to a low level. However, since the voltage level of the third node ND3 changes to a low level after the programming operation for the second anti-fuse N41, the second buffer section 43 generates the restoration signal BACK activated to a high level.

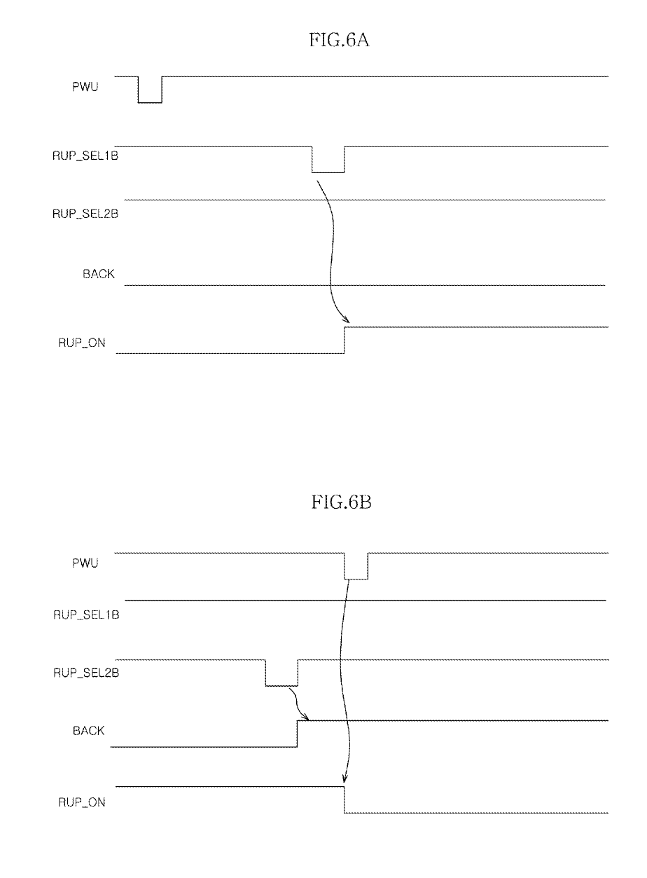

FIGS. 6A and 6B are waveform diagrams illustrating the operation of the anti-fuse circuit according to an embodiment of the present invention.

FIG. 6A is a waveform diagram illustrating the operation during first power up process.

During the first power up process, the power-up signal PWU is activated to reset the anti-fuse circuit. Then, the first rupture signal RUP_SEL1B is activated according to the fuse programming command. When no restoration command for programming is issued, the second rupture RUP_SEL2B is deactivated, and thus the restoration signal BACK is also deactivated. As a result, the output signal RUP_ON indicating that the anti-fuse was programmed is activated.

FIG. 6B is a waveform diagram illustrating the operation during power up after the programming restoration command.

When the programming operation for the anti-fuse was already completed, the first rupture signal RUP_SEL1B is deactivated at a high level. The output signal RUP_ON is activated at a high level to indicate that the anti-fuse was programmed.

However, when restoration from the fuse programming is desired, the second rupture signal RUP_SEL2B is activated, and the restoration signal BACK is activated in response to the second rupture signal RUP_SEL2B. Therefore, regardless of whether or not the anti-fuse is programmed during next power up, the output signal RUP_ON deactivated to a low level is generated indicating that the anti-fuse was not programmed.

While certain embodiments have been described above, it will be understood to those skilled in the art that the embodiments described are by way of example only. Accordingly, the anti-fuse circuit described herein should not be limited based on the described embodiments. Rather, the anti-fuse circuit described herein should only be limited in light of the claims that follow when taken in conjunction with the above description and accompanying drawings.

What is claimed is:

1. An anti-fuse circuit comprising:
a first fuse unit comprising a first anti-fuse which is determined to be short-circuited if the first anti-fuse in a programmed state and determined not to be short-circuited if the first anti-fuse in a non-programmed state, and configured to generate an output signal according to a state of the anti-fuse and a restoration signal; and
a second fuse unit comprising a second anti-fuse, and configured to activate the restoration signal when the second anti-fuse is in the programmed state in case where the first anti-fuse is in the programmed state.

2. The anti-fuse circuit according to claim 1, wherein, when is the deactivated restoration signal is received, the first fuse unit deactivates the output signal when the first anti-fuse is in the non-programmed state, and activates the output signal when the first anti-fuse is in the programmed state.

3. The anti-fuse circuit according to claim 2, wherein the first fuse unit deactivates the output signal, when the activated restoration signal is received.

4. The anti-fuse circuit according to claim 1, wherein the first fuse unit comprises:
a first reset section configured to apply an external voltage to a first node during power up;
a second reset section configured to apply the external voltage to a second node during power up;
a first anti-fuse section comprising the first anti-fuse and configured to apply a ground voltage to the first node when the first anti-fuse is in the programmed state;
a disconnection section configured to electrically disconnect the first and second nodes in response to the restoration signal; and
a first buffer section configured to buffer the voltage level of the second node and output the buffered signal as the output signal.

5. The anti-fuse circuit according to claim 1, wherein the second fuse unit comprises:
a third reset section configured to apply an external voltage to a third node during power up;
a second anti-fuse section configured to apply a ground voltage to the third node when the second anti-fuse is in the programmed state; and
a second buffer section configured to buffer the voltage level of the third node and output the buffered signal as the restoration signal.

6. An anti-fuse circuit comprising:
a control unit configured to generate first and second rupture signals;
a first fuse unit comprising a first anti-fuse, and configured to program the first anti-fuse in response to the first rupture signal, and generate an output signal according to a state of the first anti-fuse and a restoration signal; and
a second fuse unit comprising a second anti-fuse, and configured to program the second anti-fuse in response to the second rupture signal, and activate the restoration signal according to a state of the second anti-fuse.

7. The anti-fuse circuit according to claim 6, wherein the control unit activates the first rupture signal during fuse programming, and then activates the second rupture signal when the fuse programming is to be restored.

8. The anti-fuse circuit according to claim 7, further comprising a high voltage generation unit configured to generate a high voltage.

9. The anti-fuse circuit according to claim 8, wherein the first fuse unit comprises:
a first reset section configured to apply an external voltage to a first node in response to a power-up signal;
a second reset section configured to apply the external voltage to a second node in response to the power-up signal;
a first anti-fuse section comprising the first anti-fuse and configured to program the first anti-fuse in response to the activated first rupture signal, and apply a ground voltage to the first node when the first anti-fuse is in the programmed state;
a disconnection section configured to electrically disconnect the first and second nodes in response to the restoration signal; and
a first buffer section configured to buffer the voltage level of the second node and output the buffered signal as the output signal.

10. The anti-fuse circuit according to claim 9, wherein the first reset section comprises a first PMOS transistor configured to apply the external voltage to the first node in response to the power-up signal, and
the second reset section comprises a second PMOS transistor configured to apply the external voltage to the second node in response to the power-up signal.

11. The anti-fuse circuit according to claim 9, wherein the first anti-fuse section comprises:
a third PMOS transistor configured to apply the high voltage to the first node in response to the first rupture signal; and
the first anti-fuse having a gate terminal electrically connected to the first node, and configured to be short-circuited when the high voltage is applied, and electrically connect the first node to the ground voltage.

12. The anti-fuse circuit according to claim 9, wherein the disconnection section comprises a first pass gate configured to electrically connect the first and second nodes in response to the deactivated restoration signal, and electrically disconnect the first and second nodes in response to the activated restoration signal.

13. The anti-fuse circuit according to claim 8, wherein the second fuse unit comprises:
a third reset section configured to apply an external voltage to the third node in response to a power-up signal;
a second anti-fuse section configured to program the second anti-fuse in response to the activated second rupture signal, and apply a ground voltage to the third node; and
a second buffer section configured to buffer the voltage level of the third node and output the buffered signal as the restoration signal.

14. The anti-fuse circuit according to claim 13, wherein the third reset section comprises a fourth PMOS transistor configured to apply the external voltage to the third node in response to the power-up signal.

15. The anti-fuse circuit according to claim 13, where the second anti-fuse section comprises:
a fifth PMOS transistor configured to apply the high voltage to the third node in response to the second rupture signal; and
the second anti-fuse having a gate terminal electrically connected to the third node, and configured to be short-circuited when the high voltage is received, and electrically connect the third node to the ground voltage; and
a second buffer section configured to buffer the voltage level of the third node and output the buffered signal as the restoration signal.

16. An anti-fuse circuit comprising:
a high voltage generation unit configured to generate a high voltage;
a control unit configured to activate a first rupture signal during fuse programming, and then activate a second rupture signal when the fuse programming is to be restored;
a fuse unit comprising a first anti-fuse, and configured to program the first anti-fuse in response to the first rupture signal, and generate an output signal according to a state of the first anti-fuse and a restoration signal; and
a restoration control unit comprising a second anti-fuse, and configured to program the second anti-fuse in response to the second rupture signal, and activate the restoration signal according to a state of the second anti-fuse.

17. The anti-fuse circuit according to claim 16, wherein the fuse unit comprises:
a first reset section configured to apply an external voltage to a first node in response to a power-up signal;
a second reset section configured to apply the external voltage to a second node in response to the power-up signal;
a first anti-fuse section comprising the first anti-fuse and configured to program the first anti-fuse in response to the activated first rupture signal, and apply a ground voltage to the first node when the first anti-fuse is in the programmed state;
a disconnection section configured to electrically disconnect the first and second nodes in response to the restoration signal; and
a first buffer section configured to buffer the voltage level of the second node and output the buffered signal as the output signal.

18. The anti-fuse circuit according to claim 17, wherein the first anti-fuse section comprises:
a first PMOS transistor configured to apply the high voltage to the first node in response to the first rupture signal; and
the first anti-fuse having a gate terminal electrically connected to the first node, and configured to be short-circuited when the high voltage is applied, and electrically connect the first node to the ground voltage.

19. The anti-fuse circuit according to claim 16, wherein the restoration control unit comprises:
a third reset section configured to apply an external voltage to a third node in response to a power-up signal;
a second anti-fuse section configured to program the second anti-fuse in response to the activated second rupture signal, and apply a ground voltage to the third node; and
a second buffer section configured to buffer the voltage level of the third node and output the buffered signal as the restoration signal.

20. The anti-fuse circuit according to claim 19, wherein the second anti-fuse section comprises:
a second PMOS transistor configured to apply the high voltage to the third node in response to the second rupture signal;
the second anti-fuse having a gate terminal electrically connected to the third node, and configured to be short-circuited when the high voltage is applied, and electrically connect the third node to the ground voltage; and
a second buffer section configured to buffer the voltage level of the third node and output the buffered signal as the restoration signal.
